(19) United States
(12) Patent Application Publication
(10) Pub. No.: US 2005/0122053 A1
(43) Pub. Date: Jun. 9, 2005

(54) Organic electroluminescent display

(76) Inventor: Chung-Wen Ko, Sijhih City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/784,058

(22) Filed: Feb. 20, 2004

(30) Foreign Application Priority Data
Dec. 9, 2003 (TW) 92134643

(51) Int. Cl. G09G 3/10

(52) U.S. Cl. 315/169.3

(57) ABSTRACT

An organic electroluminescent display. The display has a transparent display panel, a reflective sheet and a brightness regulating film between the substrate and the reflective sheet. The regulating film is able to adjust the light intensity transmitting thereof.

### BACKGROUND OF THE INVENTION

1.Field of the Invention

The present invention relates to an organic electroluminescent display (OLED) technology and more particularly to an integrated OLED with a brightness regulating film for light transmission to achieve high contrast under different ambient light intensities.

2. Description of the Related Art

Among the new generation of flat panel techniques, organic electroluminescent display (OLED) has the advantages of self-luminescence, wide-viewing angle, thin profile, light weight, low driving voltage and simple fabrication process. Generally, a laminated structure over a glass substrate of a unit of the OLED includes a cathode, a hole injection layer, a hole transport layer, an organic electroluminescent layer, an electron transport layer, an electron injection layer and a cathode. Thus, when electrons and holes are combined as excitons in the organic luminescent layer, light radiates from the transparent faceplate.

When operating the OLED under brighter lighting conditions, the internal reflective electrodes thereof, however, reflect the external ambient light and contrast thereof is thus lowered. A conventional method for improving contrast in an OLED is the use of black light-absorption material to fabricate the electrode thereof, thus preventing reflection. Another conventional method is the use of a polarizer to regulate incident light and reflective light through the principle of interference, thereby eliminating internal reflection by destructive interference. In U.S. Pat. No. 6,211,613, an OLED structure for improving contrast and lowering power consumption is disclosed, as shown by the schematic cross-section diagram in FIG. 1. In FIG. 1, a conventional OLED device 10 includes a transparent substrate 12, an anode 14, a light emitting layer 16, a cathode 18, an insulating layer 20 and a reflective layer 22, and a circular polarizer 24 is further disposed on one side of the transparent substrate 12. The anode layer 14 material can be a transparent conductive material such as indium tin oxide (ITO), the insulating layer 20 material can be an aluminum oxide layer, and the reflective layer 22 material can be an aluminum layer, for example. In addition, the arrow symbol Lₜ illustrates an exterior light radiating into the OLED device 10, the arrow Lᵣ illustrates a reflection of the exterior light by the OLED device 10 being blocked by the circular polarizer 24, and the arrow Lₑ illustrates a light penetrating the circular polarizer 24 illuminated by the OLED device 10. Although internal reflection caused by the external ambient light can be reduced in the described manner, about 50% of light intensity illuminated by the OLED 10 is also reduced.

### SUMMARY OF THE INVENTION

Accordingly, an object of the invention is to provide a integrated OLED having a transparent display panel with a bright regulating film for light transmission capable of achieving high contrast under different ambient light intensities.

The integrated OLED of the invention has a transparent display substrate, a reflective sheet and an optical film, wherein the optical film is able to adjust transmitted-light intensity.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is cross section of a conventional OLED as referenced in the related art;

FIG. 2 is a cross section of an OLED of the invention;

FIG. 3 illustrates controlled light transmission via a optical slit in a brighter environment;

FIG. 4 illustrates controlled light transmission via a optical slit in a darker environment.

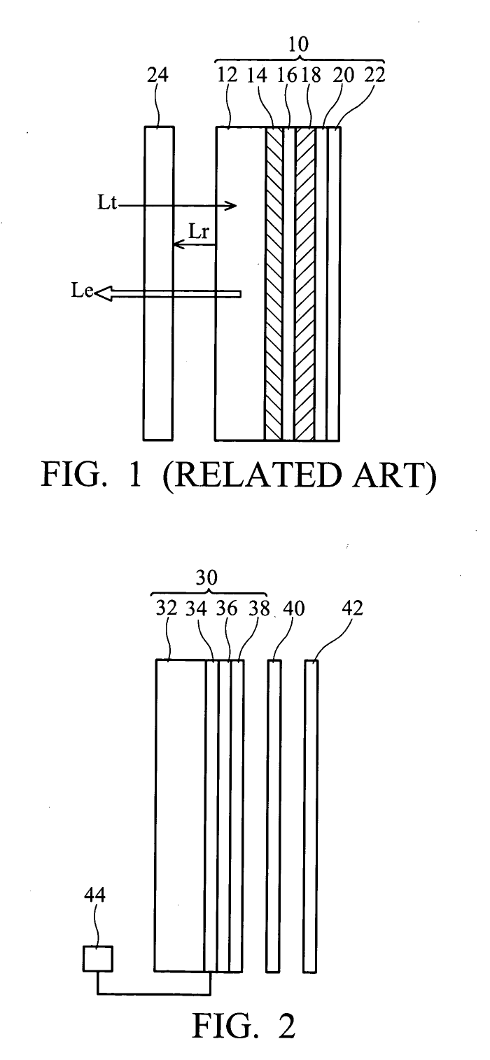

### DETAILED DESCRIPTION OF THE INVENTION

In FIG. 2, a cross section of an organic electroluminescent display (OLED) of the invention is illustrated. The OLED has a transparent display panel 30, a brightness regulating film 40 for adjusting light transmission, a reflective sheet 42 and a photo sensor 44, wherein the brightness regulating film 40 is disposed between the transparent display panel 40 and the reflective sheet 42. In addition, the transparent display panel 30 includes a transparent substrate 32, a first transparent electrode layer 34, a light-emitting layer 36 and a second transparent electrode layer 38. Preferably, the transparent substrate 32 is a glass substrate, the first transparent electrode layer 34 is an indium tin oxide (ITO) layer, the light-emitting layer 36 is an organic electroluminescent layer and the second transparent electrode layer 36 is an ITO layer. Further, a hole injection layer, a hole transport layer, an electron transport layer and an electron injection layer can be fabricated between the first transparent electrode layer 34 and the second transparent electrode layer 38.

The brightness regulating film 40 is a film such as a optical slit for controlling light intensity transmitted from the environment into the transparent display panel 30 and passing through the brightness regulating film 40 according to a light intensity detected by the photo sensor 44. Preferably, the brightness regulating film 40 is formed of electrochromic material or liquid crystal capable for controlling light transmission by adjusting a driving current applied thereon. For example, the electrochromic material is an intrinsic transparent material and can be changed into opaque or colored material after applying predetermined currents thereon.

A key feature of the invention is the use of the transparent display panel 30 with the brightness regulating film 40 disposed between the transparent display panel 30 and the reflective sheet 42 for adjusting light transmission as a main display panel to optimize contrast and brightness in an OLED.

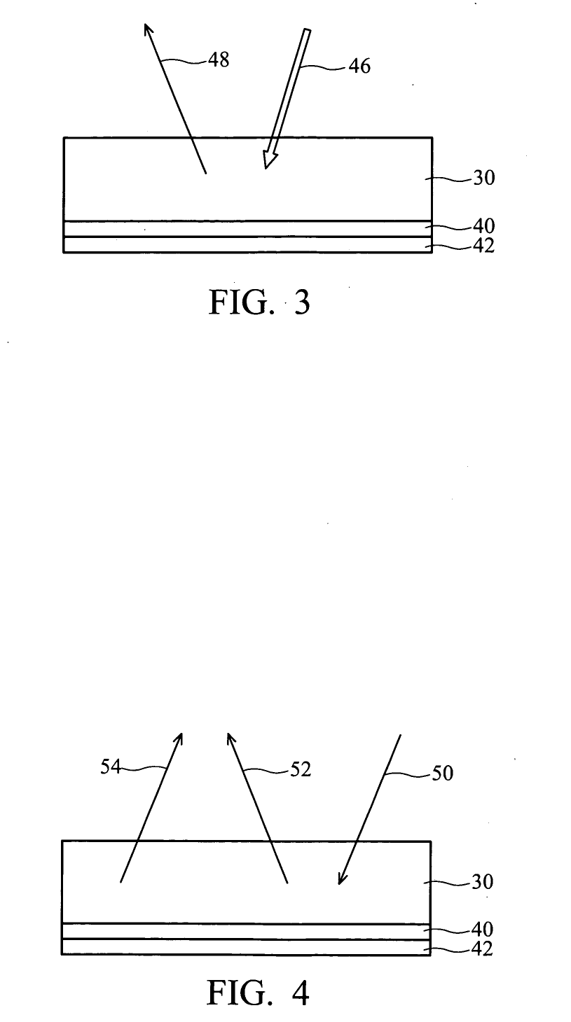

In FIG. 3, light transmission intensity through the brightness regulating film 40 can be controlled through applying different levels of current thereon and a portion of the external light 46 is absorbed by the brightness regulating film 40 while the photo sensor 44 senses light from an brighter environment, even the brightness regulating film 40 can be changed into an opaque mode to entirely block the external light 46 and absorb all the light without any reflection when the environment brighter, thus providing high contrast over the transparent display panel 30.

In FIG. 4, light transmission intensity of the brightness regulating film 40 can be controlled through applying different levels of current thereon and only a small portion of the external light 46 is absorbed by the optical film 40, while the majority of the light 52 is reflected to enhance contrast over the transparent display panel 30, even the brightness regulating film 40 can be changed to transparent mode to allow a portion of the light 54 emitted from the transparent display panel 30 reflected by the reflective sheet 42 to enhance brightness when the environment is darker. Thus, the transparent display panel 30 can achieve the same brightness when the driving current applied to the OLED is reduced.

Accordingly, the internal reflection in an OLED can be controlled by the brightness regulating film 40 of the invention and optimized contrast of the transparent display panel 30 can be maintained under environments with different light intensity without requiring the additional use of a polarizer or fabrication of light-absorbing electrodes. Insufficient display brightness can be prevented and the driving current required by the OLED can be also reduced by the use of the brightness regulating film of the invention, thus achieving merits such as lower energy consumption and high brightness.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An organic electroluminescent display, comprising:
a transparent display panel;
a reflective sheet; and
a brightness regulating film for light transmission between the transparent display panel and the reflective sheet.

2. The display as claimed in claim 1, wherein the transparent display panel further comprises:
a transparent substrate;
a first transparent electrode over the transparent substrate;
a light-emitting layer over the first transparent electrode; and
a second transparent electrode over the light-emitting layer.

3. The display as claimed in claim 2, wherein the light-emitting layer is an organic electroluminescent film.

4. The display as claimed in claim 1, wherein the brightness regulating film is an optical slit to control light transmission from the environment.

5. The display as claimed in claim 4, wherein the brightness regulating film is made of electrochromic material or liquid crystal capable for controlling light transmission thereon by adjusting current applied thereto.

6. The display as claimed in claim 1, further comprising a photo sensor to detect light intensity of the environment.

7. The display as claimed in claim 6, wherein the brightness regulating film adjusts the light transmission intensity from the environment according to a light intensity of the environment detected by the photo sensor.

8. The display as claimed in claim 1, wherein the brightness regulating film adjusts a light-transmitting mode thereof by controlling current intensity applied thereon according to a light intensity of the environment as detected by the photo sensor.
